(19) United States
(12) Patent Application Publication
(10) Pub. No.: US 2026/0001701 A1
(43) Pub. Date: Jan. 1, 2026

(54) INSULATED PACKAGING ASSEMBLY WITH MULTI-LAYER A-B LINER

(71) Applicant: Pratt Corrugated Holdings, Inc., Brookhaven, GA (US)

(72) Inventors: Matt Smith, Tucker, GA (US); Greg Sollie, Sharpsburg, GA (US); Alex Tanner, Atlanta, GA (US); Shifeng Chen, Newport News, VA (US); Bob Feldman, Cincinnati, OH (US); Paul Ott, Atlanta, GA (US)

(21) Appl. No.: 19/248,197

(22) Filed: Jun. 24, 2025

Related U.S. Application Data
(60) Provisional application No. 63/665,946, filed on Jun. 28, 2024.
(60) Provisional application No. 63/803,120, filed on May 9, 2025.

(51) Int. Cl. B65D 81/38; B29C 48/00; B29C 59/04; B29L 7/00; B29L 9/00; B29L 31/00; B32B 3/12; B32B 7/12; B32B 27/16; B32B 27/32; B32B 38/06

(52) U.S. Cl. CPC B65D 81/3823; B29C 48/002; B29C 48/0021; B29C 59/04; B32B 3/12; B32B 7/12; B32B 27/16; B32B 27/32; B32B 38/06; B29C 2791/001; B29C 2791/002; B29L 2007/001; B29L 2007/008; B29L 2009/008; B29L 2031/7162; B32B 2307/72; B32B 2323/043; B32B 2553/026

(57) ABSTRACT

A bubble A-B liner insulation package includes a box defining a box cavity, an A-liner configured to be positioned in the box cavity, the A-liner constructed from a first panel of liner material defining three A-liner portions, and a B-liner configured to be positioned in the box cavity adjacent to the A-liner, the B-liner constructed from a second panel of liner material defining three B-liner portions. The liner material comprises at least a first bubble layer formed from a thermoplastic film, an upper layer joined to an upper side of the bubble layer, and a lower layer joined to a lower side of the bubble layer, wherein at least one of the thermoplastic film, the upper layer, and the lower layer is at least partially comprised of metallized high density polyethylene (MHDPE).

### REFERENCE TO RELATED APPLICATIONS

This application claims the benefit of U.S. Provisional Application No. 63/803, 120, filed on May 9, 2025, and U.S. Provisional Application No. 63/665,946, filed on Jun. 28, 2024. The entire disclosure of each of the above applications noted above is incorporated herein by reference in its entirety.

### TECHNICAL FIELD

This disclosure relates to boxes. More specifically, this disclosure relates to an insulated packaging assembly.

### RELATED ART

Boxes are commonly used to ship a payload comprising food, perishables, or medicines. Such payloads can comprise a single item or a combination of items. For many reasons it is desirable during shipment to maintain such temperature-sensitive items in a cold or hot condition, that is, above or below ambient temperature, depending on which condition is appropriate for the particular payload being shipped.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a bubble A-B liner insulation package for transporting temperature-sensitive items, comprising a box comprising sidewalls defining a first side panel, a second side panel opposite the first side panel, a third side panel, and a fourth side panel opposite the third side panel, the box further comprising a box bottom connected to at least one of the sidewalls, wherein the sidewalls and the bottom at least partially define a box cavity, the sidewalls at upper ends further defining a box opening; an A-liner configured to be positioned in the box cavity, the A-liner constructed from a first panel of liner material defining a first liner bend line and a second liner bend line spaced from the first liner bend line, the first liner bend line and the second liner bend line dividing the A-liner into a first A-liner end portion, a central A-liner portion, and a second A-liner end portion; and a B-liner configured to be positioned in the box cavity adjacent to the A-liner, the B-liner constructed from a second panel of liner material defining a third liner bend line and a fourth liner bend line spaced from the third liner bend line, the third liner bend line and the fourth liner bend line dividing the B-liner into a first B-liner end portion, a central B-liner portion, and a second B-liner end portion; wherein the liner material comprises at least a first bubble layer formed from a thermoplastic film, the bubble layer defining an upper side and a lower side, an upper metallized layer joined to the upper side of the bubble layer, and a lower metallized layer joined to the lower side of the bubble layer, wherein at least one of the thermoplastic film, the upper metallized layer, and the lower metallized layer is at least partially comprised of metallized high density polyethylene (MHDPE).

In another aspect, disclosed is a method of manufacturing liner material, comprising the steps of extruding a thermoplastic film from a plastic extruder; passing the thermoplastic film through a first nip defined between an upper embossing roll and a lower embossing roll, one of the upper embossing roll and lower embossing roll defining a plurality of bubble-shaped recesses, the other of the upper embossing roll and the lower embossing roll defining a plurality of bubble-shaped protuberances complimentary in shape to the bubble-shaped recesses; rotating the upper embossing roll and the lower embossing roll to emboss the thermoplastic film and to thereby form a bubble layer from the thermoplastic film, the bubble layer defining an upper side and a lower side; laminating an upper metallized layer onto the upper side of the bubble layer; and laminating a lower metallized layer onto the lower side of the bubble layer to form a first panel of encapsulated bubble material; wherein at least one of the thermoplastic film, the upper metallized layer, and the lower metallized layer is at least partially comprised of metallized high density polyethylene (MHDPE).

Various implementations described in the present disclosure can comprise additional systems, methods, features, and advantages, which might not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations can be realized and obtained by means of the systems, methods, features particularly pointed out in the appended claims. These and other features will become more fully apparent from the following description and appended claims or can be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures can be designated by matching reference characters for the sake of consistency and clarity.

FIG. 1 is an exploded perspective view of a bubble A-B liner insulation package for transporting temperature-sensitive items, the package constructed in accordance with an aspect of the current disclosure.

FIG. 2A is a plan view of a first panel of liner material comprising the A-liner of the A-B liner insulation package illustrated in FIG. 1, from the perspective of viewing the inner surface of the first panel.

FIG. 2B is a plan view of a second panel of liner material comprising the B-liner of the A-B liner insulation package illustrated in FIG. 1, from the perspective of viewing the inner surface of the second panel.

FIG. 3A is a perspective view of the bubble A-B liner insulation package of FIG. 1 shown in a partially assembled state, with the top flaps of a box and lid portion of the A-liner assuming an open position.

FIG. 3B is an enlarged detail view of a portion of FIG. 3A, illustrating a tight seam formed at a junction of respective edges of the A-liner and B-liner, the junction fitting snugly against a corner defined by the box.

FIG. 4A is a plan view of a panel of bubble liner material from which the A-liner and B-liner of FIG. 1 are formed and further illustrating the machine direction in which the panel travels during its manufacturing process.

FIG. 4B is a side view, along the machine direction, of the panel of bubble liner material illustrated in FIG. 4A.

FIGS. 4C and 4D are a front views of the panel of bubble liner material illustrated in

FIG. 4A from a perspective perpendicular to the machine direction.

FIG. 5 is a front view of a panel of bubble liner material constructed in accordance with another aspect of the present disclosure from a perspective perpendicular to the machine direction.

FIG. 6A is a front perspective view of the panel of bubble liner material illustrated in FIGS. 4A-4D.

FIG. 6B is a top perspective view of the panel of bubble liner material illustrated in FIGS. 4A-4D.

FIG. 7 is a perspective view of a panel of bubble material constructed in accordance with an aspect of the present disclosure partially separating along a perforated line to reveal bubbles formed as hemispherical elements.

FIG. 8 is a system diagram illustrating stations executing steps in the manufacture of a panel of bubble material in accordance with an aspect of the present disclosure.

FIG. 9A is a perspective view of the upper embossing roll illustrated in FIG. 8.

FIG. 9B is an enlarged detail view of a portion of FIG. 9A, showing a pattern of concave dome-shaped recessed portions formed into the upper embossing roll illustrated in FIG. 9A.

FIG. 10 is a front view, from a perspective perpendicular to the machine direction, of a panel of bubble liner material constructed in accordance with another aspect of the present disclosure

FIG. 11 is a front view, from a perspective perpendicular to the machine direction, of a panel of bubble liner material constructed in accordance with another aspect of the present disclosure.

FIG. 12 is a front view, from a perspective perpendicular to the machine direction, of a panel of bubble liner material constructed in accordance with another aspect of the present disclosure.

FIG. 13 is a plan view of a first panel and a second panel of liner material comprising the A-liner and the B-liner, respectively, of the A-B liner insulation package illustrated in FIG. 1, showing a pattern of applying adhesives to adjoin adjacent bubble layers.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” might be referenced. Unless stated otherwise, “front” describes that end of a blank or an assembled box or any portion thereof nearest to a primary or initial point of opening; “rear” is that end of the blank or the assembled box or any portion thereof that is opposite or distal the front; “left” is that which is to the left of or facing left from a person facing towards the front; and “right” is that which is to the right of or facing right from that same person facing towards the front. “Horizontal” or “horizontal orientation” describes that which is in a plane extending from left to right and aligned with the horizon. “Vertical” or “vertical orientation” describes that which is in a plane that is angled at 90degrees to the horizontal.

As disclosed in the figures disclosing liners 102,104 and the panel of bubble material 400, various line thicknesses and types can indicate certain characteristics of the geometry. In some aspects, a thicker solid line can indicate the edge of a part; a thinner solid line can indicate a bend line; a dash or dashed line can indicate a hidden edge (and edge covered by other geometry), a perforated cut or connection, or a boundary or boundaries of a detail view; a dot-dash line can indicate material that is cut away and not shown for clarity, and a double dot-dash line can indicate a boundary or boundaries of separately claimable elements. Unless otherwise specified, a geometric center of any thicker lines determine the shape and position of the disclosed geometry. Dimensions disclosed in the figures are recited in inches but are exemplary only, and it is contemplated that the panel 400 and the liners 102, 104 formed therefrom can be any shape and size.

Except where stated otherwise, lines described herein as “fold lines” or “bend lines” do not require creases, scores, etc. that denote a physical feature. Bend lines or fold lines are the lines about which adjacent portions of an element bend relative to one another. The present application discloses materials that may plastically deform to leave a crease as well as those that do not leave a crease upon being bent or folded, particularly when the bend radius is sufficiently large and/or the film material is sufficiently thin. Likewise, fibrous and/or resilient materials can be folded without leaving a crease. Further, even materials that plastically deform to leave creases when folded, such as a sheet of paper, may be creaseless and completely planar before being folded, which can qualify as “an unfolded configuration.”

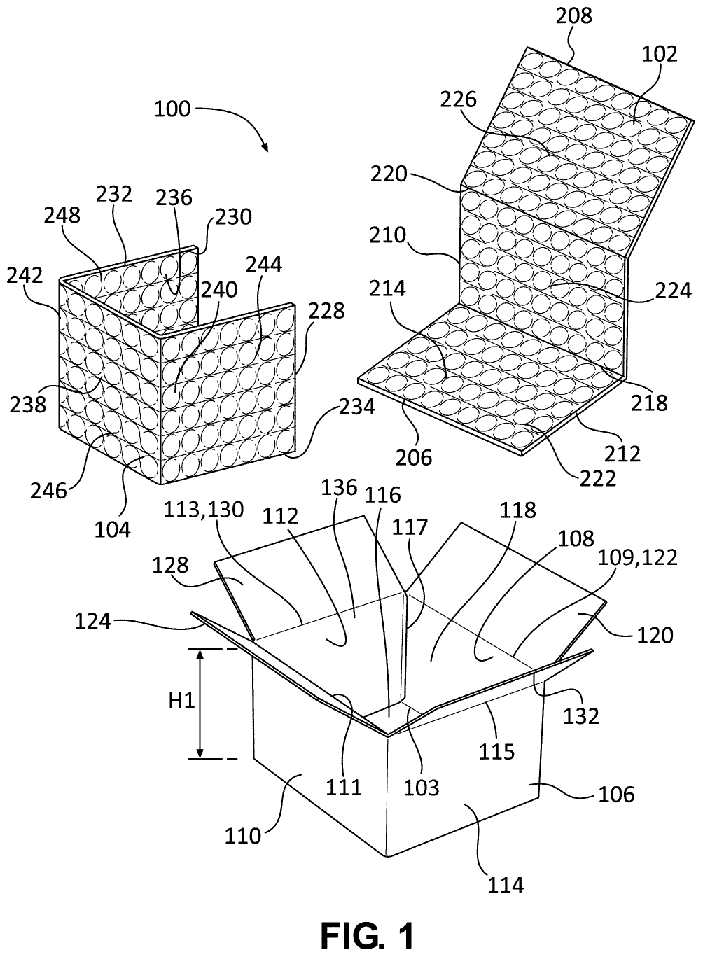

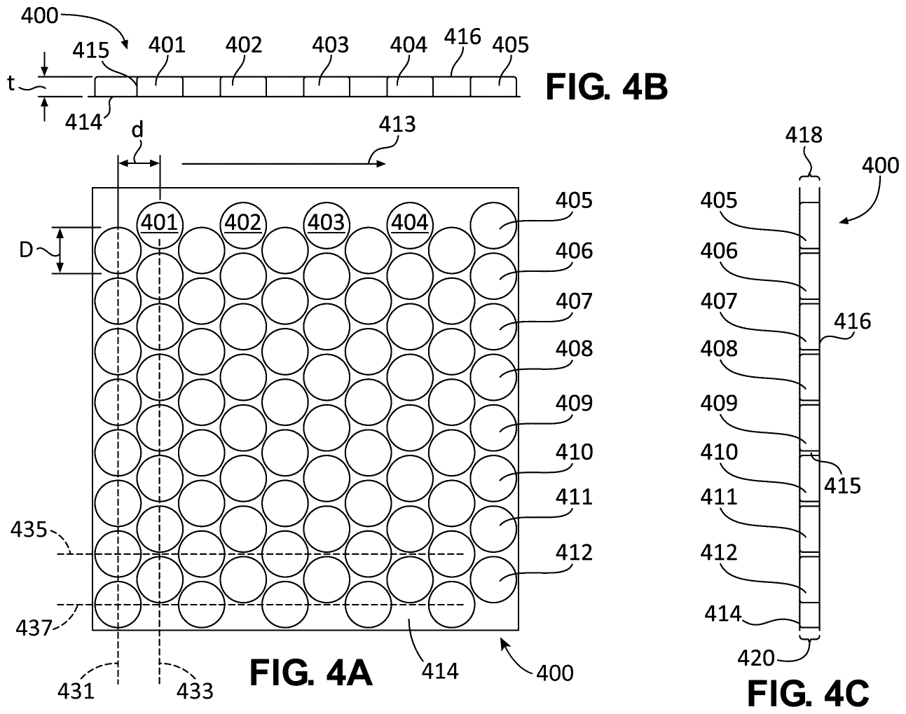

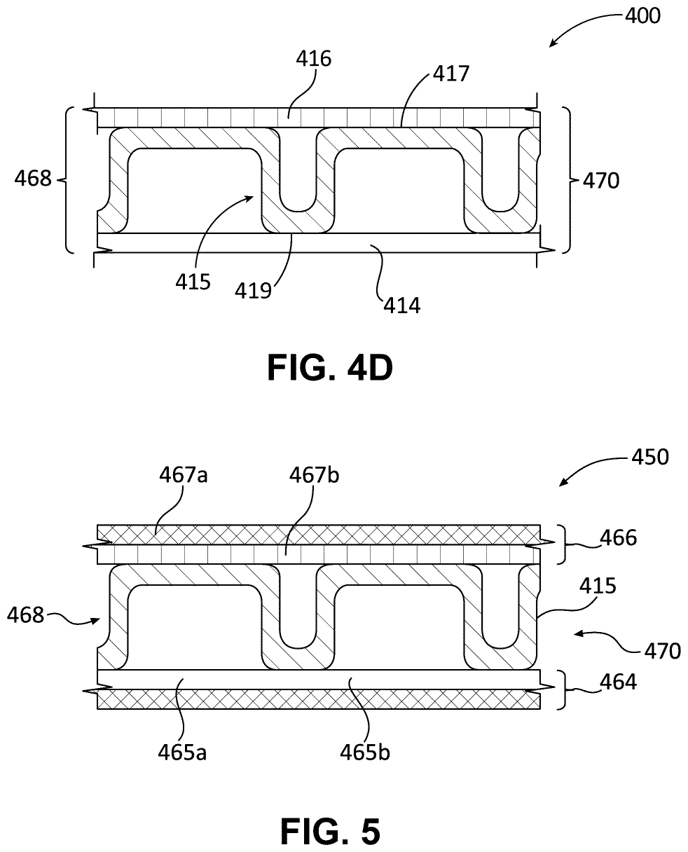

FIG. 1 is an exploded perspective view of a bubble A-B liner insulation package 100 for transporting temperature-sensitive items, the package 100 constructed in accordance with an aspect of the current disclosure. The package 100 can comprise an A-liner 102, a B-liner 104, and a box 106. In some embodiments, liner material 400 (FIG. 4A)—of which the liners 102, 104 can be constructed—can be partially comprised of recycled material in a quantity ranging from and including 15% of the liner material 400 up to and including 40% of the liner material 400. The box 106 can be comprised of corrugated cardboard and constructed as a regular slotted container (RSC), though other suitable materials and constructions for the box 106 are contemplated as being within the scope of the present disclosure. Box 106 can be comprised entirely of curbside recyclable material, such as double-layered recyclable corrugated cardboard. Alternatively, box 106 can be constructed entirely of repulpable material or can be comprised of some elements that can be comprised of curbside recyclable material and some other elements that can be comprised of repulpable material. The liners 102, 104 and the box 106 can be physically detached from one another when assembled so that the liners 102, 104 can be discarded into one recycling stream while the box 106 can be discarded into another recycling stream.

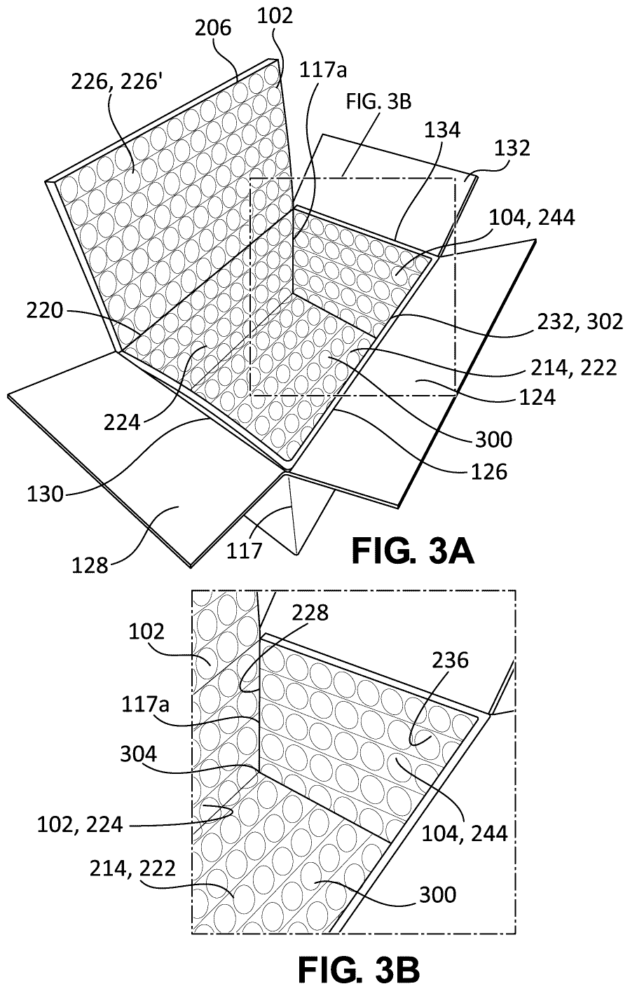

The box 106 can comprise sidewalls defining a first side panel 108, a second side panel 110 opposite the first side panel 108, a third side panel 112 adjacent the first side panel 108 and the second side panel 110, and a fourth side panel 114 opposite the third side panel 112. The box 106 can comprise a bottom 116 connected to a bottom edge 103 of at least one of the sidewalls 108, 110, 112, 114. The bottom 116 can be comprised of one or more bottom flaps (not shown) as would be understood by one of skill in the art. Together, the sidewalls 108, 110, 112, 114 and the bottom 116 can at least partially define a box cavity 118. The sidewalls 108, 110, 112, 114 can each define a box height (H1). Adjacent ends of the sidewalls 108, 110, 112, 114 can meet to form corners such as at a corner 117 of the box 106 between the first side panel 108 and the third side panel 112. The box 106 can further comprise a first top flap 120 joined to the first side panel 108 by a fold line 122, a second top flap 124 joined to the second side panel 110 by a fold line 126 (FIG. 3A), a third top flap 128 joined to the third side panel 112 by a fold line 130, and a fourth top flap 132 joined to the fourth side panel 114 by a fold line 134 (FIG. 3A). The box cavity 118 can be further defined upon closure of the top flaps 120, 124, 128, 132, as these top flaps cover an upper opening 136 of the box 106 that would otherwise be defined at the upper ends 109, 111, 113, 115 of the sidewalls 108, 110, 112, 114, respectively. The box 106 of the present aspects can define a substantially rectangular cross-sectional shape. However, in various aspects, the number of side and end panels can vary and/or the cross-sectional shape of the box 106 can vary-for example, the box 106 can define a triangular, square, or circular cross-sectional shape, or any other suitable cross-sectional shape. The box 106 can also comprise more or fewer top and bottom panels than those disclosed with regard to the present aspects of the current disclosure.

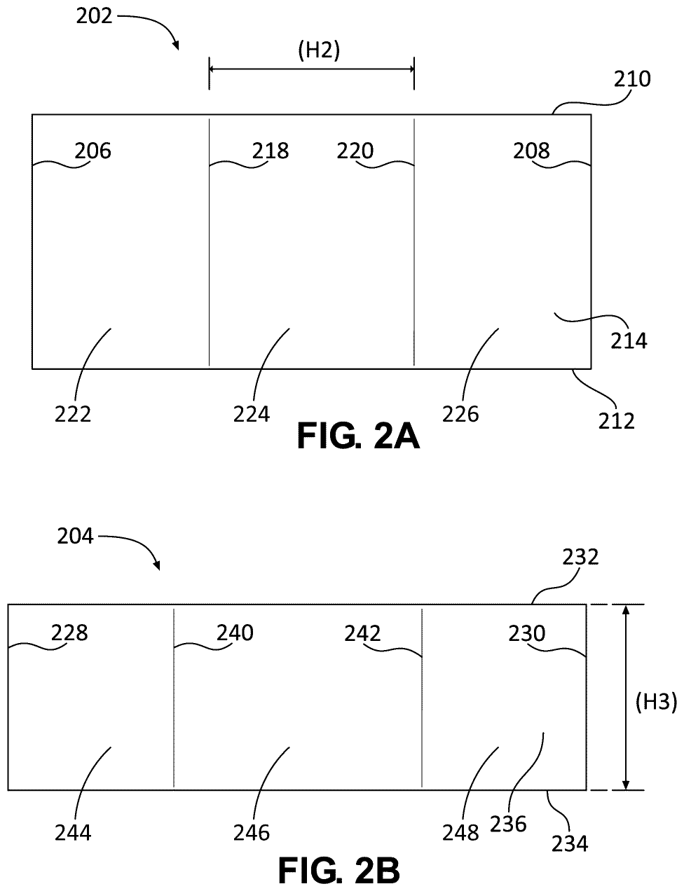

Referring to FIGS. 1-3B, the A-liner 102 can be configured to be positioned in the box cavity 118. The A-liner 102 can be constructed from a first panel 202 of liner material 400 (FIG. 4A). The first panel 202 can define a first A-liner end 206, an opposed second A-liner end 208 spaced from the first A-liner end 206, a first longitudinal A-liner edge 210 extending between the first A-liner end 206 and the second A-liner end 208, and a second longitudinal A-liner edge 212 extending between the first A-liner end 206 and the second A-liner end 208 opposite the first longitudinal A-liner edge 210. The first panel 202 can further define an inner A-liner surface 214, an outer A-liner surface 216 (not shown, opposite side of the inner A-liner surface 214), a first liner bend line 218, and a second liner bend line 220 spaced from the first liner bend line 218. The first liner bend line 218 and the second liner bend line 220 can divide the first panel 202 (A-liner 102) into a first A-liner end portion 222, a central A-liner portion 224, and a second A-liner end portion 226. Finally, the first panel 202 (A-liner 102) can define an A-liner height (H2), shown in FIG. 2A to be slightly greater than 12 inches, although dimensions provided in the present disclosure are exemplary and not intended to be limiting.

The B-liner 104 can be configured to be positioned in the box cavity 118 adjacent to the A-liner 102. The B-liner 104 can be constructed from a second panel 204 of the liner material 400 (FIG. 4A) The second panel 204 can define a first B-liner end 228, a second B-liner end 230 spaced from the first B-liner end 228, a first longitudinal B-liner edge 232 extending between the first B-liner end 228 and the second B-liner end 230, and a second longitudinal B-liner edge 234 extending between the first B-liner end 228 and the second B-liner end 230 opposite the first longitudinal B-liner edge 232. The second panel 204 can further define an inner B-liner surface 236, an outer B-liner surface 238, a third liner bend line 240, and a fourth liner bend line 242 spaced from the third liner bend line 240. The third liner bend line 240 and the fourth liner bend line 242 can divide the second panel 204 (B-liner 104) into a first B-liner end portion 244, a central B-liner portion 246, and a second B-liner end portion 248. Finally, the second panel 204 (B-liner 104) defines a B-liner height (H3), shown in FIG. 2B to be 11 ⅞ inches, although dimensions provided in the present disclosure are exemplary and not intended to be limiting.

Referring now more particularly to FIGS. 3A and 3B, the positioning of the A-liner 102 and the B-liner 104 within the box cavity 118 (FIG. 1) will now be described in greater detail. As the A-liner 102 and the B-liner 104 can both be seated in the box cavity 118, the A-liner surface 214 and the B-liner inner surface 236 together define an insulated cavity 300 within the box cavity 118. The A-liner 102 can be seated in the box cavity 118 such that the outer A-liner surface 216 (not shown, opposite side of the inner A-liner surface 214) at one of the A-liner end portions (here, the first A-liner end portion 222) can contact the box bottom 216 (FIG. 1), the outer A-liner surface 216 at the central A-liner portion 224 can contact one of the sidewalls (here, for example, the first side panel 108), and the other of the A-liner end portions (here, the second A-liner portion 226) can define a liner lid 226′ hinged to the central A-liner portion 224 at the second liner bend line 220. In another aspect, the size of one of the A-liner end portion (here, the first A-liner end portion 222) that contacts the box bottom 216 can be doubled so that the A-liner end portion can be folded over double to increase the thickness of the A-liner end portion that insulates the box bottom 216. The B-liner 104 can be seated in the box cavity 118 (FIG. 1) such that one of the first longitudinal B-liner edge 232 and the second longitudinal B-liner edge 234 (here, the second longitudinal B-liner edge 234) can rest atop the A-liner end portion contacting the box bottom 216 (FIG. 1) or, as shown in FIGS. 3A and 3B, for example, atop the inner surface 214 of the first A-liner end portion 222. The other of the first longitudinal B-liner edge 232 and the second longitudinal B-liner longitudinal edge 234 (here, the first longitudinal B-liner edge 232) can define a liner ridge 302. The outer B-liner surface 238 (FIG. 1) can contact the sidewalls of the box 106 that are not contacted by the outer A-liner surface 216 (not shown) at the central A-liner portion 224. In the example of FIGS. 3A and 3B, the outer surface 216 of the B-liner 104 can contact the second side panel 110 at the central B-liner portion 246, can contact the third side panel 112 at the second B-liner end portion 248, and can contact the fourth side panel 114 at the first B-liner end portion 244.

Still referring to FIGS. 3A and 3B, a B-liner end 228 comprising one of the first B-liner end 228 and the second B-liner end 230 (here, for example, the first B-liner end 228) can contact the inner A-liner surface 214 at the central A-liner portion 224 to define a tight seam 117a (fitting against corner 117 of the box 106 (FIG. 1)) between the second B-liner end 230 and the central A-liner portion 224. The tight seam 117a can limit any air gaps between the second B-liner end 230 and the central A-liner portion 224. Additionally, the magnitudes of the box height (H1) (FIG. 1), the A-liner height (H2) (FIG. 2A) and the B-liner height (H3) (FIG. 2B) can be selected and determined so as to effect compressive force upon the A-liner 102 and the B-liner 104 when the liner lid 226′ closes across the liner ridge 302 and when the top flaps 120, 124, 128, 132 of the box 106 are closed across the box opening 136. In particular, if box height (H1) is less than the A-liner height (H2) and also less than the B-liner height (H3), then the closure of the top flaps 120, 124, 128, 132 induces compression upon the liner lid 226′, which transmits that compressive force to the remainder of the A-liner 102 and to the B-liner 104. This compression can effect a sealing engagement of the A-liner 102 and the B-liner 104 with one another and with the box 106, and the sealing engagement, in turn can enhance the thermal performance of the liners 102, 104 when in use.

The liner material 400 comprising the first liner panel 202 (FIG. 2A) and the second liner panel 204 (FIG. 2B) will now be discussed in greater detail with reference to FIGS. 4A-7. The liner material 400 can comprise a bubble layer 415 formed from a thermoplastic film. The bubble layer 415 can define an upper side 417 and a lower side 419, an upper metallized layer 416 joined to the upper side of the bubble layer 415, and a lower metallized layer 414 joined to the lower side of the bubble layer 415. At least one of the thermoplastic film can comprise the bubble layer 415, the upper metallized layer 416, and the lower metallized layer 414 can be at least partially comprised of metallized high density polyethylene (MHDPE). In some embodiments, all of the layers 414, 415, 416 can be partially comprised of MHDPE. In the step of metallization, the metal film can comprise one or more metals, metallic elements, metal alloys, polymers, salts, silicon, or other suitable materials, such as aluminum. The film material can be vaporized, deposited to form the metal film, and coupled as the metal film to its thermoplastic substrate. However, such substrates can instead be coated with a metallic film by a process known as “flexo coating,” and the foregoing description of the metallization step is not intended to be limiting. Thus, in some aspects, the upper (outer) surface of the bubble layer 415, the upper (outer) surface of the upper metallized layer 416, and the lower (outer) surface of the lower metallized layer 416 can all be metallized. The term “high density,” as used in the term represented by the MHDPE acronym, can mean that the metallized polyethylene present in any or all of the layers 414, 415, 416 can possess a density ranging from and including 931 kg/m³ to and including 970 kg/m³. This high density can promote the ability of the liners 102, 104 to fit together in a sealing engagement in the manner described above with regard to FIGS. 3A and 3B.

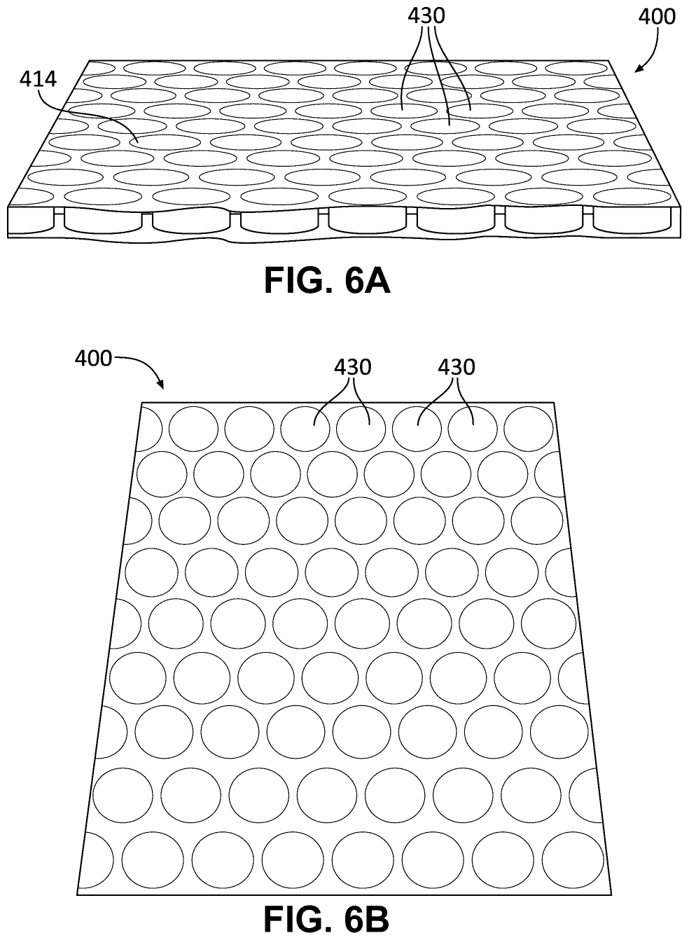

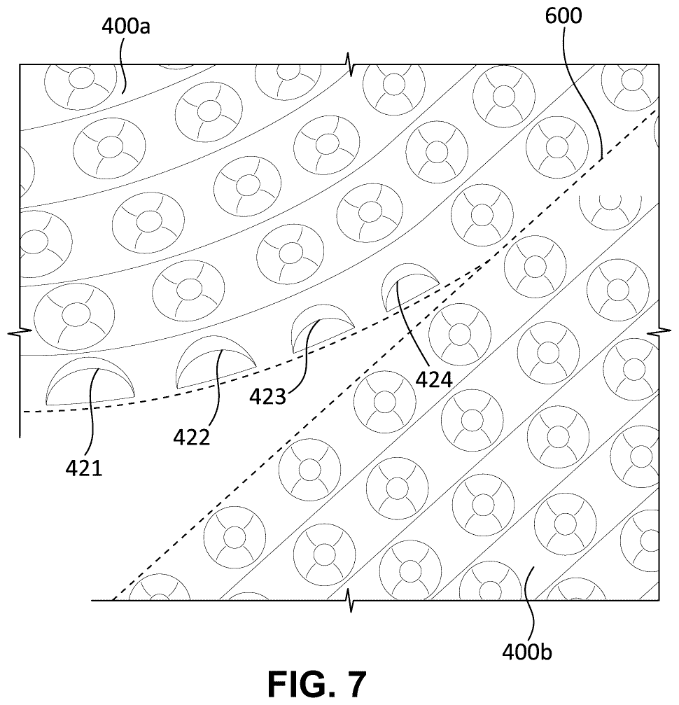

As best seen in FIGS. 4A-4C, the liner material 400 can exhibit an encapsulated structure, with a plurality of formed bubbles such as bubbles 401-412 sandwiched between the lower metallized layer 414 and the upper metallized layer 416. However, as best seen in FIG. 4C, the sides 418, 420 of the panel of material 400 can be open. This open configuration can be acceptable because, as will be discussed herein in greater detail with regard to FIG. 7, the bubbles themselves can avoid being punctured and therefore can maintain the volumes of air trapped therein. As shown in FIG. 4B, the encapsulated bubbles 401-412 can be arranged in rows both horizontally (such as encapsulated bubbles 401-404) and vertically (such as encapsulated bubbles 405-412) so that the encapsulated bubbles in adjacent rows can be staggered. For example, in one aspect of the present disclosure, the distance (d) between axes—such as vertical axes 431, 433 and horizontal axes 435, 437—can be substantially the same as the diameter (D) of the encapsulated bubbles 401-412. In other aspects, the spacing between axes of adjacent rows can differ so that the encapsulated bubbles 401-412 of adjacent rows are not staggered. As seen in FIGS. 6A and 6B, exemplary bubbles 430 can be viewed.

In some aspects of the present disclosure, at least one of the lower metallized layer 414 and the upper metallized layer 416 can be comprised of a single layer of metallized film. However, in other aspects of the present disclosure, as exemplified by the liner material 450 of FIG. 5, one or both of a lower metallized layer 464 and an upper metallized layer 466 can be comprised of a double layer of film. In some aspects of the present disclosure, only one of the film layers of the lower metallized layer 464 and the upper metallized layer 466 can be comprised of a metallized film layer. For example, as best seen in FIG. 5, outermost film layers 465a and 467a of the lower metallized layer 464 and upper metallized layer 466, respectively, can be comprised of metallized film layers. However, in some aspects of the present disclosure, both innermost film layers 465b and 467b of the lower metallized layer 464 and upper metallized layer 466, respectively, can be metallized film layers. In manner similar to that described with regard to the panel of material 400, the material 450 can also have open sides 468, 470.

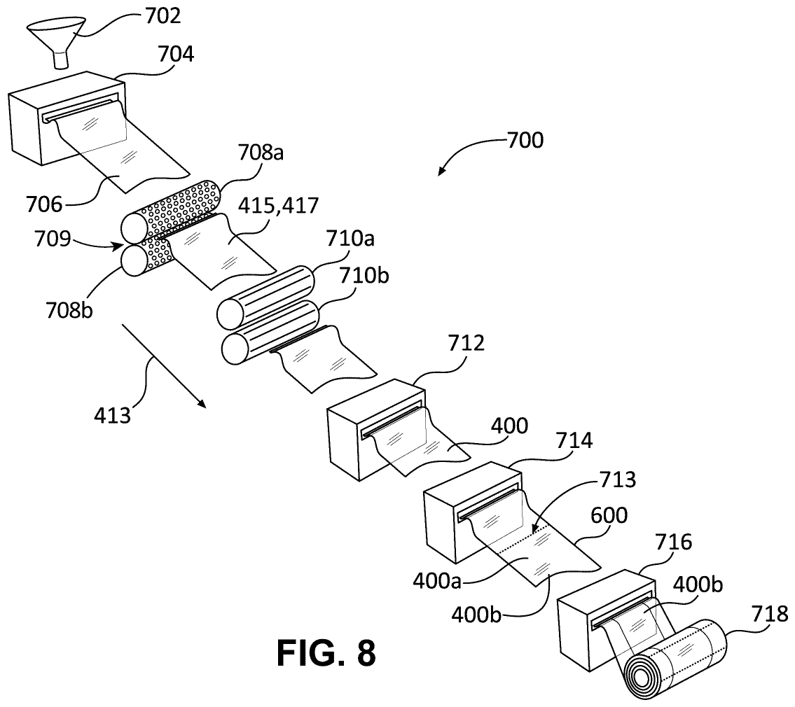

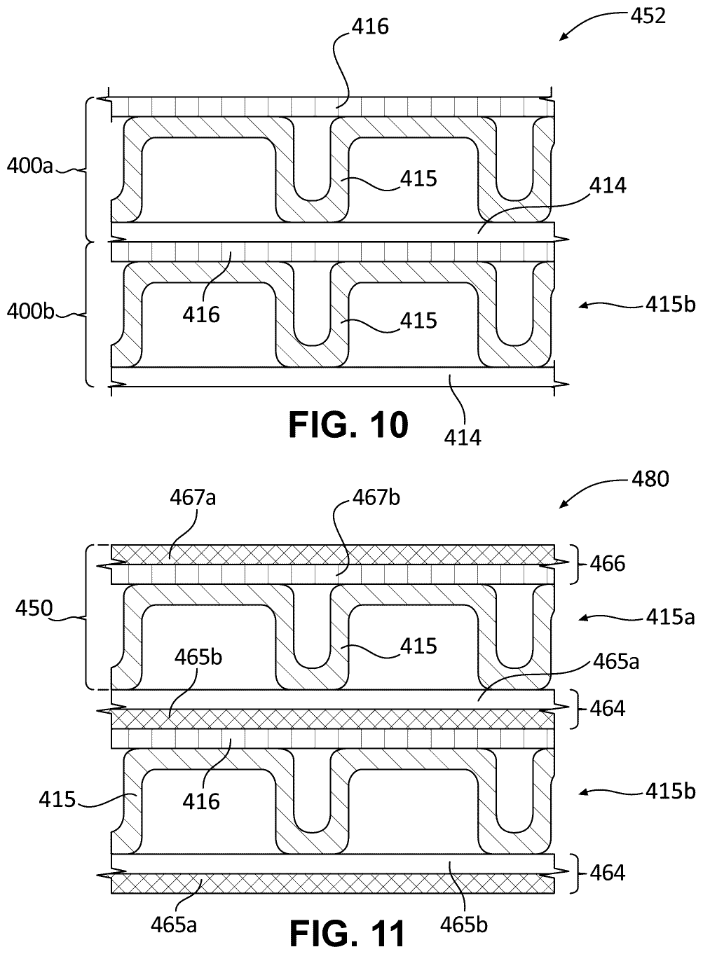

In some aspects of the present disclosure, as exemplified by a liner material 452 of FIG. 10, multiple encapsulated bubble layers can be joined together. For example, the liner material 452 shown in FIG. 10 can comprise a first encapsulated bubble layer 400a constructed similarly to the liner material 400 described above with regard to FIGS. 4A-4D. Additionally, a second encapsulated bubble layer 400b can be joined to the lower metallized layer 414 of the first encapsulated bubble layer 400a. The second encapsulated bubble layer 400b can be joined to the first encapsulated bubble layer 400a by a lamination process, as described in greater detail below with regard to FIG. 8. In other aspects of the present disclosure, the multiple encapsulated bubble layers such as, but not limited to, first encapsulated bubble layer 400a and second encapsulated bubble layer 400b, can be joined together by adhesives to form the liner material of the A-liner 102 and B-liner 104 (FIG. 1). An exemplary pattern of applying adhesive 107 to the liner material is shown in FIG. 13, although various other patterns of applying the adhesive 107 can be utilized in alternate embodiments.

In some aspects of the present disclosure, as exemplified by a liner material 480 of FIG. 11, multiple encapsulated bubble layers can be joined together. For example, the liner material 480 shown in FIG. 11 can comprise a first encapsulated bubble layer 415a constructed similarly to the liner material 450 described above with regard to FIG. 5. Additionally, a second encapsulated bubble layer 415b can be joined to the lower metallized layer 464 of the first encapsulated bubble layer 415a. The second encapsulated bubble layer 415b can be joined to the first encapsulated bubble layer 415a by a lamination process, as described in the discussion of FIG. 8 that follows. In other aspects of the present disclosure, the multiple encapsulated bubble layers such as, but not limited to first encapsulated bubble layer 415a and second encapsulated bubble layer 415b, can be joined together by adhesives to form the liner material of the A-liner 102 and B-liner 104 (FIG. 1). An exemplary pattern of applying adhesive 107 to the liner material is shown in FIG. 13, although various other patterns of applying the adhesive 107 can be utilized in alternate embodiments. As shown, the second encapsulated bubble layer 415b can be constructed similarly to the first encapsulated bubble layer 415a and can omit the outermost upper metalized film layer 467. As such, a single metalized film layer 465 can be disposed between the first and the second encapsulated bubble layers 415a and 415b. However, in some aspects of the present disclosure, the second encapsulated bubble layer 415b can also comprise a metallized outermost film layer 467 on the upper metallized layer 466.

In yet another aspect of the present disclosure, a third encapsulated bubble layer (not shown) can be joined to the first encapsulated bubble layer 415a and second encapsulated bubble layer 415b. For example, a third encapsulated bubble layer can be joined to the first encapsulated bubble layer 415a and the second encapsulated bubble layer 415b shown in FIG. 11 such that the third encapsulated bubble layer can be arranged between the first encapsulated bubble layer 415a and the second encapsulated bubble layer 415b. As well, the third encapsulated bubble layer can lack any metallized film layers.

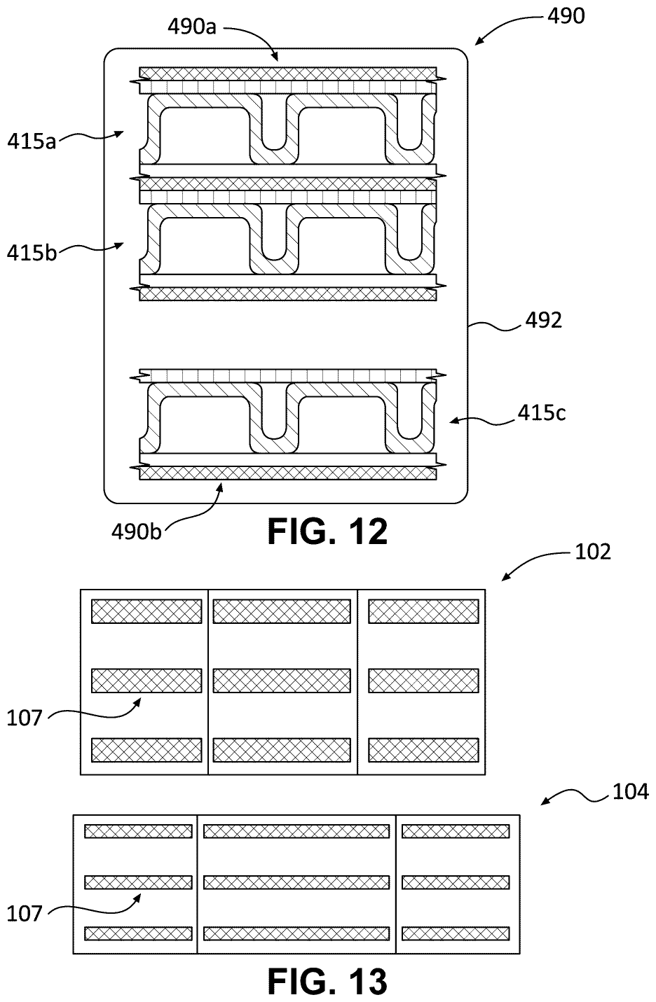

In some aspects of the present disclosure, as exemplified by the liner material 490 of FIG. 12, multiple encapsulated bubble layers can be joined together in a sealed sleeve 492 that can be formed from thermoplastic material. For example, the liner material 490 shown in FIG. 12 can comprise a first layer of liner material 490a that can comprise a first encapsulated bubble layer 415a joined to a second encapsulated bubble layer 415b, similarly to the liner material 480 shown in FIG. 11, and a second layer of liner material 490b that can be sealed adjacent to each other in sealed sleeve 492.

FIG. 7 is a perspective view of a panel of bubble material such as that used for liners 102, 104, constructed in accordance with an aspect of the present disclosure partially separating along a perforated line 600 to reveal bubbles, exemplified at 421-424, formed as hemispherical elements, the panel divided by the separation into a first panel section 400a and a second panel section 400b. The hemispherical bubble shapes shown in FIG. 7 are merely exemplary and are not intended to be limiting. This separation can occur as a manufacturing step as will be described below with regard to FIG. 8. In aspects of the present disclosure, the separation along the perforated line 600 does not result in a loss of air in bubbles such as the bubbles 421-424, because the cutting the panel of encapsulated bubble material is performed with a cutting roller in conjunction with application of a heat seal to the cut edges of the first panel section 400a and the second panel section 400b. Maintaining the air volume in the bubbles can enhance rigidity of the liners 102, 104 and can allow for more accurate sizing of the liners 102, 104 for compression sealing purposes in the manner described above.

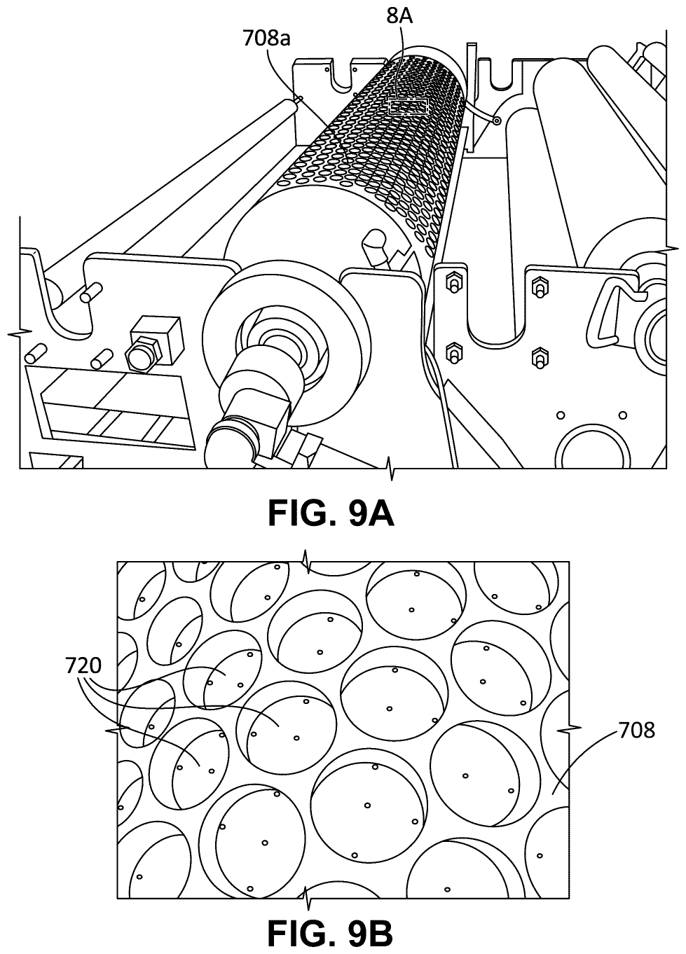

A method of manufacturing the panel of liner material 400 is now described with reference to FIGS. 8, 9A, and 9B. The method can begin with depositing resin pellets into a funnel 702 communicating with an internal chamber of a plastic extruder 704. The deposited pellets can be melted in the plastic extruder 704 to produce a thermoplastic film 706. The thermoplastic film 706 can then be passed through a first nip 709 defined between embossing rolls (collectively referenced at 708). The embossing rolls 708a, 708b can comprise an upper embossing roll 708a (FIG. 9A) and a lower embossing roll 708b. A first one of the embossing rolls 708a, 708b can define a plurality of bubble-shaped recesses, and a second one of the embossing rolls 708a, 708b can define a plurality of bubble-shaped protuberances complimentary in shape to the bubble-shaped recesses of the first one of the embossing rolls 708a, 708b. In the example of FIGS. 9A and 9B, the upper embossing roll 708a can define a plurality of bubble-shaped recesses 720. The embossing rolls 708 can be rotated to emboss the thermoplastic film 706 and to thereby form the bubble layer 415 from the thermoplastic film 706. The bubble layer 415 can define an upper side 417 and a lower side 419 (FIG. 4D). Next, the bubble layer 415 can be passed through top and bottom laminator rolls 710a,b, which respectively can bond the lower metallized layer 414 to the lower side of the bubble layer 415 and the upper metallized layer 416 to the upper side of the bubble layer 415. The resulting material exiting the laminator rolls 710a,b can be the encapsulated bubble liner material 400 previously described with regard to FIGS. 6A, 6B, and 7. Among other things, at least one of the thermoplastic film 706, the upper metallized layer 416, and the lower metallized layer 414 can be at least partially comprised of MHDPE, and the layers 414,416 can be comprised of either single or double layers of metallized films. The panel of the encapsulated bubble liner material 400 can then be routed in the machine direction 413 to a first perforation station 712 which can form a fold line 713 in the material 400. The panel of encapsulated bubble liner material 400 can then be further routed in the machine direction 413 to a second perforation station 714, to form the tear line 600 in the encapsulated bubble liner material 400. At a slit station 716, the encapsulated bubble liner material 400 can be separated into portions in the manner described above with regard to FIG. 7. The separated panel section 400b can then be rolled onto a roll 718 for shipment to a customer.

In some aspects of the present disclosure, the above described method of

manufacturing a panel of bubble liner material can be utilized to produce liner material including multiple layers of encapsulated bubble material 4000, such as those shown and described above with regard to FIGS. 10-12. For example, prior to routing the encapsulated bubble liner material 400 shown in FIG. 8 to the first perforation station 712, a second panel of encapsulated bubble liner material 400, or third, can be joined to the first panel of encapsulated bubble liner material 400 at an additional laminator station.

In some aspects, any of the panels and flaps of the liners 102, 104 and the box 106 that are described as being rectangular can be substantially rectangular (i.e., rectangular in shape minus any notches, chamfers, or other edge treatments). In some aspects, any of the panels and flaps of the liners 102, 104 and the box 106 that are described as being rectangular can define some non-rectangular shape can be substantially that shape (i.e., that shape minus any notches, chamfers, or other edge treatments).

Components of the liners 102,104 and the box 106 and their arrangement can comprise both functional and aesthetic elements, and any feature described as having functional aspects can have or define any one of several aesthetic designs without altering the respective parts' functions. If aesthetic elements are shown in the drawings or possibly fall within the scope of broader claim elements without being directly claimed, such disclosure or claims should not be interpreted as assigning any function to such aesthetic elements which can therefore be separately protectable.

One should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions might not be included or executed at all, can be executed out of order from that shown or discussed, including substantially concurrently or in reverse order, depending on the functionality involved, as would be understood by those reasonably skilled in the art of the present disclosure. Many variations and modifications can be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A liner insulation package for transporting temperature-sensitive items, the liner insulation package comprising:
a box comprising sidewalls defined by a first side panel, a second side panel opposite the first side panel, a third side panel adjacent to the first side panel and the second side panel, and a fourth side panel opposite the third side panel, the box further comprising a box bottom connected to at least one of the sidewalls, wherein the sidewalls and the box bottom at least partially define a box cavity, the sidewalls at upper ends further defining a box opening;
an A-liner configured to be positioned in the box cavity, the A-liner constructed from a first panel of liner material defining a first liner bend line and a second liner bend line spaced from the first liner bend line, the first liner bend line and the second liner bend line dividing the A-liner into a first A-liner end portion, a central A-liner portion, and a second A-liner end portion; and
a B-liner configured to be positioned in the box cavity adjacent to the A-liner, the B-liner constructed from a second panel of liner material defining a third liner bend line and a fourth liner bend line spaced from the third liner bend line, the third liner bend line and the fourth liner bend line dividing the B-liner into a first B-liner end portion, a central B-liner portion, and a second B-liner end portion;
wherein the liner material comprises at least a first bubble layer formed from a first thermoplastic film, the bubble layer defining an upper side and a lower side, an upper metallized layer joined to the upper side of the bubble layer, and a lower metallized layer joined to the lower side of the bubble layer, wherein at least one of the thermoplastic film, the upper metallized layer, and the lower metallized layer is at least partially comprised of metallized high density polyethylene (MHDPE).

2. The liner insulation package of claim 1, wherein the liner material further comprises a second bubble layer formed from a second thermoplastic film, the second bubble layer defining an upper side and a lower side, and a lower metallized layer joined to the lower side of the second bubble layer, wherein the upper side of the second bubble layer is joined to the lower metallized layer of the first bubble layer.

3. The liner insulation package of claim 2, wherein the liner material further comprises a third bubble layer formed from a third thermoplastic film, the third bubble layer defining an upper side and a lower side, and a lower metallized layer joined to the lower side of the third bubble layer, wherein the upper side of the third bubble layer is joined to the lower metallized layer of the second bubble layer.

4. The liner insulation package of claim 3, wherein the third bubble layer is joined to the second bubble layer by an adhesive.

5. The liner insulation package of claim 1, wherein the upper metallized layer and the lower metallized layer of the first bubble layer each comprise a first material layer and a second material layer.

6. The liner insulation package of claim 5, wherein at least one of the first material layer and the second material layer of the first bubble layer comprises a metallized film.

7. The liner insulation package of claim 1, wherein the MHDPE has a density ranging from and including 931 kg/m³ to and including 970 kg/m³.

8. The liner insulation package of claim 1, wherein at least one of the first thermoplastic film, the upper metallized layer, and the lower metallized layer are at least further partially comprised of recyclable material.

9. The liner insulation package of claim 8, wherein a quantity of the liner material comprises the recyclable material, the quantity ranging from and including 15% of the liner material to and including 40% of the liner material.

10. The liner insulation package of claim 1, wherein at least one of the lower metallized layer and the upper metallized layer of the first bubble layer are comprised of a single layer of metallized film.

11. The liner insulation package of claim 1, wherein at least one of the lower metallized layer and the upper metallized layer of the first bubble layer are comprised of a double layer of metallized film.

12. The liner insulation package of claim 1,
wherein the A-liner further defines a first A-liner end and a second A-liner end spaced from the first A-liner end, a first longitudinal A-liner edge extending between the first A-liner end and the second A-liner end, and a second longitudinal A-liner edge extending between the first A-liner end and the second A-liner end opposite the first longitudinal A-liner edge, the A-liner further defining an inner A-liner surface and an outer A-liner surface;
wherein the B-liner further defines a first B-liner end and a second B-liner end spaced from the first B-liner end, a first longitudinal B-liner edge extending between the first B-liner end and the second B-liner end, and a second longitudinal B-liner edge extending between the first B-liner end and the second B-liner end opposite the first longitudinal B-liner edge, the B-liner further defining an inner B-liner surface and an outer B-liner surface;
wherein the A-liner is seated in the box cavity such that the outer A-liner surface at one of the A-liner end portions can contact the box bottom, the outer A-liner surface at the central A-liner portion can contact one of the sidewalls, and the other of the A-liner end portions defines a liner lid;
wherein the B-liner is seated in the box cavity such that one of the first longitudinal B-liner edge and the second longitudinal B-liner edge rests atop the A-liner end portion contacting the box bottom, the other of the first longitudinal B-liner edge and the second longitudinal B-liner longitudinal edge defines a liner ridge, and such that the outer B-liner surface can contact the sidewalls of the box that are not contacted by the outer A-liner surface at the central A-liner portion;
wherein a B-liner end consisting of one of the first B-liner end and the second B-liner end can contact the inner A-liner surface at the central A-liner portion to define a tight seam between the B-liner end and the central A-liner portion, the tight seam excluding any air gaps between the B-liner end and the central A-liner portion.

13. The bubble liner insulation package of claim 12,
wherein the A-liner as seated in the box cavity defines an A-liner height;
wherein the B-liner as seated in the box cavity defines a B-liner height;
wherein the box further defines a first top flap joined to the first side panel by a first fold line, a second top flap joined to the second side panel by a second fold line, a third top flap joined to the third side panel by a third fold line, and a fourth top flap joined to the fourth side panel by a fourth fold line, each of the sidewalls defining a box height, the box height smaller than the A-liner height and smaller than the B-liner height;
wherein the A-liner and the B-liner undergo compression upon closure of the liner lid across the liner ridge and closure of the first top flap, the second top flap, the third top flap, and the fourth top flap across the box opening, the compression effecting a sealing engagement of the A-liner and the B-liner with one another and with the box.

14. A method of manufacturing a panel of liner material, comprising the steps of:
extruding a thermoplastic film from a plastic extruder;
passing the thermoplastic film through a first nip;
embossing the thermoplastic film to thereby form a bubble layer from the thermoplastic film, the bubble layer defining an upper side and a lower side;
laminating an upper metallized layer onto the upper side of the bubble layer; and
laminating a lower metallized layer onto the lower side of the bubble layer to form a first panel of encapsulated bubble material;
wherein at least one of the thermoplastic film, the upper metallized layer, and the lower metallized layer is at least partially comprised of metallized high density polyethylene (MHDPE).

15. The method of claim 14, further comprising the steps of forming a second panel of encapsulated bubble material and laminating the second panel of encapsulated bubble material to the lower metallized layer of the first panel of encapsulated bubble material.

16. The method of claim 15, wherein the second panel of encapsulated bubble material comprises an upper layer and a lower metallized layer, and the upper layer is joined to the lower metallized layer of the first panel of encapsulated bubble material.

17. The method of claim 16, further comprising the steps of forming a third panel of encapsulated bubble material and joining the third panel of encapsulated bubble material to the lower metallized layer of the second panel of encapsulated bubble material

18. The method of claim 14, wherein the upper metallized layer and the lower metallized layer of the first panel of encapsulated bubble material each comprise a first material layer and a second material layer.

19. The method of claim 18, wherein at least one of the first material layer and the second material layer of the first panel of encapsulated bubble material comprises a metallized film.

20. The method of claim 18, wherein at least one of the upper metallized layer and the lower metallized layer comprises a double layer of metallized films.

21. The method of claim 14, wherein the first nip is defined between an upper embossing roll and a lower embossing roll, a first one of the upper embossing roll and lower embossing roll defining a plurality of bubble-shaped recesses, a second one of the upper embossing roll and the lower embossing roll defining a plurality of bubble-shaped protuberances complimentary in shape to the bubble-shaped recesses.

22. The method of claim 21, wherein embossing the thermoplastic film further comprises rotating the upper embossing roll and the lower embossing roll.

23. A liner insulation package for transporting temperature-sensitive items, the liner insulation package comprising:
a first liner panel constructed from a first panel of liner material; and
a second liner panel constructed from a second panel of liner material;
wherein the liner material comprises at least a first bubble layer formed from a thermoplastic film, the bubble layer defining an upper side and a lower side, an upper layer joined to the upper side of the bubble layer, and a lower layer joined to the lower side of the bubble layer, wherein at least one of the thermoplastic film, the upper layer, and the lower layer is at least partially comprised of metallized high density polyethylene (MHDPE).

24. The liner insulation of claim 23, further comprising:
a box comprising sidewalls defined by a first side panel, a second side panel opposite the first side panel, a third side panel adjacent to the first side panel and the second side panel, and a fourth side panel opposite the third side panel, the box further comprising a box bottom connected to at least one of the sidewalls, wherein the sidewalls and the box bottom at least partially define a box cavity, the sidewalls at upper ends further defining a box opening;
an A-liner constructed from the first liner panel, the A-liner configured to be positioned in the box cavity, the A-liner constructed from a first panel of liner material defining a first liner bend line and a second liner bend line spaced from the first liner bend line, the first liner bend line and the second liner bend line dividing the A-liner into a first A-liner end portion, a central A-liner portion, and a second A-liner end portion; and
a B-liner constructed from the second liner panel, the B-liner configured to be positioned in the box cavity adjacent to the A-liner, the B-liner constructed from a second panel of liner material defining a third liner bend line and a fourth liner bend line spaced from the third liner bend line, the third liner bend line and the fourth liner bend line dividing the B-liner into a first B-liner end portion, a central B-liner portion, and a second B-liner end portion.
